(19) United States
(12) Patent Application Publication
(10) Pub. No.: US 2002/0144130 A1
(43) Pub. Date: Oct. 3, 2002

(54) Apparatus and methods for detecting illicit content that has been imported into a secure domain

(75) Inventors: Martin Rosner, Cortlandt Manor, NY (US); Raymond Krasinski, Suffern, NY (US); Michael A. Epstein, Spring Valley, NY (US); Antonius A.M. Staring, Eindhoven (NL)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/011,890

(22) Filed: Dec. 6, 2001

Related U.S. Application Data
(60) Provisional application No. 60/279,639, filed on Mar. 29, 2001.

(51) Int. Cl. G06F 12/14

(52) U.S. Cl. 713/188

(57) ABSTRACT

Apparatus and methods for detecting illicit content that has been imported into a secure domain, thereby preventing an attack on a screening algorithm. A method of preventing an attack on a screening algorithm includes the steps of determining whether content submitted to a screening algorithm contains indicia indicating that the content is protected, admitting the content into a segregated location of a secure domain if it is determined that the content does not contain indicia indicating that the content is protected, and monitoring the content within the segregated location to detect whether any editing activity is performed on the content. The content is admitted into the segregated location only when it is determined that the content does not contain indicia indicating that the content is protected. The method also includes the step of determining whether the edited content contains indicia indicating that the content is protected, after editing activity is detected.

### CROSS REFERENCE TO RELATED APPLICATION

This application claims priority to the U.S. provisional patent application identified by Serial No. 60/279,639, filed on Mar. 29, 2001, the disclosure of which is incorporated by reference herein.

### FIELD OF THE INVENTION

The present invention relates generally to the field of secure communication, and more particularly to techniques for preventing an attack on a screening algorithm.

### BACKGROUND OF THE INVENTION

Security is an increasingly important concern in the delivery of music or other types of content over global communication networks such as the Internet. More particularly, the successful implementation of such network-based content delivery systems depends in large part on ensuring that content providers receive appropriate copyright royalties and that the delivered content cannot be pirated or otherwise subjected to unlawful exploitation.

With regard to delivery of music content, a cooperative development effort known as Secure Digital Music Initiative (SDMI) has recently been formed by leading recording industry and technology companies. The goal of SDMI is the development of an open, interoperable architecture for digital music security. This will answer consumer demand for convenient accessibility to quality digital music, while also providing copyright protection so as to protect investment in content development and delivery. SDMI has produced a standard specification for portable music devices, the SDMI Portable Device Specification, Part 1, Version 1.0, 1999, and an amendment thereto issued later that year, each of which are incorporated by reference.

The illicit distribution of copyright material deprives the holder of the copyright legitimate royalties for this material, and could provide the supplier of this illicitly distributed material with gains that encourage continued illicit distributions. In light of the ease of information transfer provided by the Internet, content that is intended to be copy-protected, such as artistic renderings or other material having limited distribution rights, are susceptible to wide-scale illicit distribution. For example, the MP3 format for storing and transmitting compressed audio files has made the wide-scale distribution of audio recordings feasible, because a 30 or 40 megabyte digital audio recording of a song can be compressed into a 3 or 4 megabyte MP3 file. Using a typical 56 kbps dial-up connection to the Internet, this MP3 file can be downloaded to a user's computer in a few minutes. Thus, a malicious party could read songs from an original and legitimate CD, encode the songs into MP3 format, and place the MP3 encoded song on the Internet for wide-scale illicit distribution. Alternatively, the malicious party could provide a direct dial-in service for downloading the MP3 encoded song. The illicit copy of the MP3 encoded song can be subsequently rendered by software or hardware devices, or can be decompressed and stored onto a recordable CD for playback on a conventional CD player.

A number of schemes have been proposed for limiting the reproduction of copy-protected content. SDMI and others advocate the use of “digital watermarks” to identify authorized content. U.S. Pat. No. 5,933,798, “Detecting a watermark embedded in an information system,” issued Jul. 16, 1997 to Johan P. Linnartz, discloses a technique for watermarking electronic content, and is incorporated by reference herein. As in its paper watermark counterpart, a digital watermark is embedded in the content so as to be detectable, but unobtrusive. An audio playback of a digital music recording containing a watermark, for example, will be substantially indistinguishable from a playback of the same recording without the watermark. A watermark detection device, however, is able to distinguish these two recordings based on the presence or absence of the watermark. Because some content may not be copy-protected and hence may not contain a watermark, the absence of a watermark cannot be used to distinguish legitimate from illegitimate material.

Other copy protection schemes are also available. For example, European Patent No. EP983687A2, “Copy Protection Schemes for Copy-protected Digital Material,” issued Mar. 8, 2000 to Johan P. Linnartz and Johan C. Talstra, presents a technique for the protection of copyright material via the use of a watermark “ticket” that controls the number of times the protected material may be rendered, and is incorporated by reference herein.

An accurate reproduction of watermarked content will cause the watermark to be reproduced in the copy of the watermarked content. An inaccurate, or lossy reproduction of watermarked content, however, may not provide a reproduction of the watermark in the copy of the content. A number of protection schemes, including those of the SDMI, have taken advantage of this characteristic of lossy reproduction to distinguish legitimate content from illegitimate content, based on the presence or absence of an appropriate watermark. In the SDMI scenario, two types of watermarks are defined: “robust” watermarks, and “fragile” watermarks. A robust watermark is one that is expected to survive a lossy reproduction that is designed to retain a substantial portion of the original content, such as an MP3 encoding of an audio recording. That is, if the reproduction retains sufficient information to allow a reasonable rendering of the original recording, the robust watermark will also be retained. A fragile watermark, on the other hand, is one that is expected to be corrupted by a lossy reproduction or other illicit tampering.

In the SDMI scheme, the presence of a robust watermark indicates that the content is copy-protected, and the absence or corruption of a corresponding fragile watermark when a robust watermark is present indicates that the copy-protected content has been tampered with in some manner. An SDMI compliant device is configured to refuse to render watermarked material with a corrupted watermark, or with a detected robust watermark but an absent fragile watermark, except if the corruption or absence of the watermark is justified by an “SDMI-certified” process, such as an SDMI compression of copy-protected content for use on a portable player. For ease of reference and understanding, the term “render” is used herein to include any processing or transferring of the content, such as playing, recording, converting, validating, storing, loading, and the like. This scheme serves to limit the distribution of content via MP3 or other compression techniques, but does not affect the distribution of counterfeit unaltered (uncompressed) reproductions of content material. This limited protection is deemed commercially viable, because the cost and inconvenience of downloading an extremely large file to obtain a song will tend to discourage the theft of uncompressed content.

Despite SDMI and other ongoing efforts, existing techniques for secure distribution of music and other content suffer from a number of significant drawbacks. For example, SDMI has recently proposed the use of a new screening algorithm referred to as SDMI Lite. The SDMI Lite algorithm only screens sections of content having a predetermined duration of time. This limited amount of screening leaves the SDMI Lite and other content based screening algorithms susceptible to successful attacks wherein the illicit content is partitioned into sections which are shorter than the predetermined duration of time set by the screening algorithm. Subsequently, the partitioned content can be re-assembled after the SDMI Lite algorithm accepts the content into the SDMI secure domain.

Thus, a need exists for a method of preventing an attack on a content screening algorithm whereby the attacker is attempting to circumvent the screening algorithm by partitioning the content into small sections.

### SUMMARY OF THE INVENTION

The present invention provides apparatus and methods for detecting illicit content that has been imported into a secure domain, thereby preventing an attack on a screening algorithm. The invention is generally directed to reducing an attacker's chances of successfully utilizing illicit content within the SDMI domain, while balancing concerns associated with a reduction in performance time and efficiency caused by the enhancements to the screening algorithm.

In accordance with one aspect of the present invention, a method of preventing an attack on a screening algorithm includes the steps of determining whether content submitted to a screening algorithm contains indicia indicating that the content is protected from downloading, admitting the content into a segregated location of a secure domain if it is determined that the content does not contain indicia indicating that the content is protected from downloading, and monitoring the content within the segregated location to detect whether any editing activity is performed on the content. The method also includes the step of determining whether the edited content contains indicia indicating that the content is protected from downloading after editing activity is detected. If, after editing activity is detected, the content does contain indicia indicating that the content is protected from downloading, the content will be rejected from admission into the SDMI domain. If not, the content will be admitted into the SDMI domain.

These and other features and advantages of the present invention will become more apparent from the accompanying drawings and the following detailed description.

### BRIEF DESCRIPTION OF THE DRAWINGS

FIG. 1 is a schematic diagram illustrating a general overview of the present invention;

FIG. 2 is a flow diagram illustrating the steps of a method for detecting illicit content that has been imported into a secure domain in accordance with an illustrative embodiment of the present invention;

FIG. 3 is a flow diagram illustrating the steps of a method for detecting illicit content that has been imported into a secure domain in accordance with another illustrative embodiment of the present invention; and

FIG. 4 is a flow diagram illustrating the steps of a method for detecting illicit content that has been imported into a secure domain in accordance with yet another illustrative embodiment of the present invention.

### DETAILED DESCRIPTION OF THE INVENTION

The present invention provides apparatus and methods for detecting illicit content that is being or has been imported into a secure domain (e.g., the SDMI domain), thereby preventing an attack on a screening algorithm. Typically, the illicit content is detected based on the presence or absence of a watermark. The invention is generally directed to reducing an attacker's chances of successfully utilizing illicit content within the secure domain, while balancing concerns associated with a reduction in performance time and efficiency caused by the enhancements to the screening algorithm.

Advantageously, the invention prevents attacks on content-based security screening algorithms. The prevention of successful attacks on screening algorithms in accordance with the present invention will provide convenient, efficient and cost-effective protection for all content providers.

One goal of SDMI is to prevent the unlawful and illicit distribution of content on the Internet. In an attempt to accomplish this goal, SDMI has proposed methods of screening content that has been marked to be downloaded. One such proposal is the previously-mentioned SDMI Lite screening algorithm.

Generally, screening algorithms randomly screen a predetermined number of sections of the marked content to determine whether the content is legitimate. The number of sections screened may be as few as one or two sections or all sections of the content may be screened. However, even when the entire content is screened, the screening algorithms typically only screen sections having a predetermined duration of time. That is, the screening algorithm will not screen sections of content that do not exceed a certain threshold value (such as, e.g., a section must be at least fifteen seconds long to meet the threshold value and therefore be subjected to the screening algorithm). Thus, content which is less than fifteen seconds in length will not trigger the screening algorithm. These sections will be automatically admitted into the SDMI domain. Therefore, screening algorithms are susceptible to an attack whereby content is partitioned into sections which are shorter in duration than the predetermined duration of time and which are then re-assembled into an original content.

The reason that the screening algorithms are susceptible to this type of attack is two-fold. One, as discussed above, when the content is partitioned into sections having such a short duration, the screening algorithm may not be launched at all and the content will be freely admitted into the SDMI domain. The second part of the reason takes advantage of the fact that content which does not contain a watermark is freely admitted into the SDMI domain. Therefore, by partitioning the content into such small pieces, a watermark is not detected by the screening algorithm and the content is admitted into the SDMI domain. The new screening algorithm in accordance with the present invention provides an effective solution to the vulnerability of existing screening algorithms.

One way in which an attack on content based screening methods is successfully accomplished is by partitioning the content into sections wherein each section has a duration which is less than a threshold duration set forth by the screening algorithm. Therefore, when the content which has been partitioned into a number of sections is subjected to the screening algorithm, at least a portion of the content will be admitted past the screening algorithm since the individual sections are not of sufficient duration to cause the screening algorithm to be launched. Additionally, even if the section is detected, the partitioning process destroys the watermark in a manner such that the section still may verify correctly through the screening algorithm.

The screening algorithms described herein include the SDMI Lite algorithm and other content-based screening algorithms, such as the CDSafe algorithm. The CDSafe algorithm is described more fully in pending U.S. patent application Ser. No. 09/536,944, filed Mar. 28, 2000, in the name of inventors Toine Staring, Michael Epstein and Martin Rosner, entitled “Protecting Content from Illicit Reproduction by Proof of Existence of a Complete Data Set via Self-Referencing Sections,” and incorporated by reference herein.

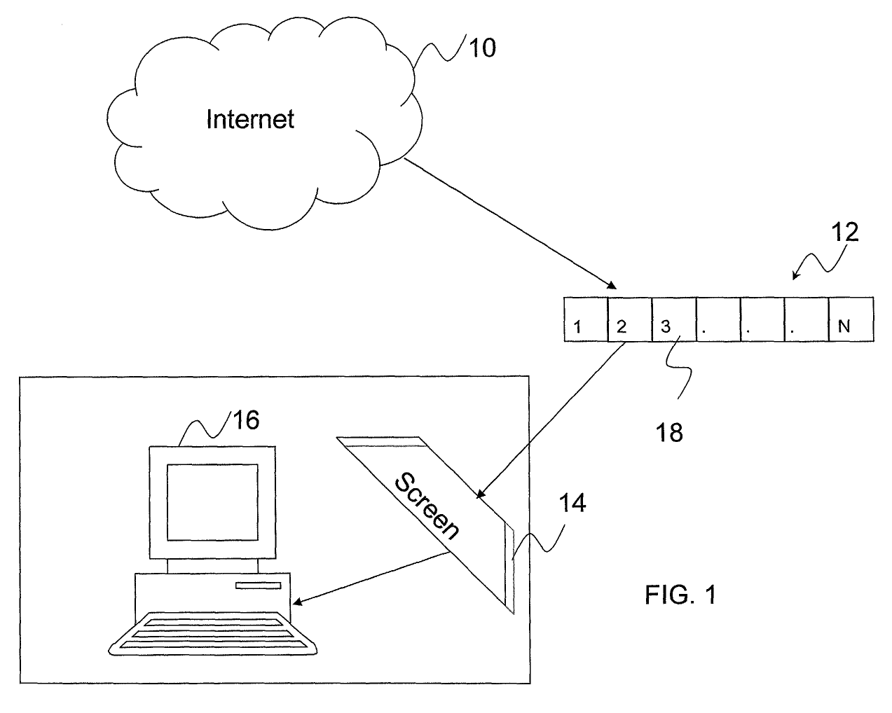

Referring now to FIG. 1, one method of attacking the proposed SDMI Lite screening algorithm and the CDSafe algorithm is to partition content 12 that is identified and proposed to be downloaded from an external source such as, for example, the Internet 10. This method of attack is described more fully in U.S. patent application entitled “Apparatus and Methods for Attacking a Screening Algorithm Based on Partitioning of Content” having Attorney Docket No. US010203, which claims priority to U.S. Provisional Patent Application No. 60/283,323, the content of which is incorporated by reference herein.

As used herein, the term “partition” refers to the act of separating content that the attacker knows to be illegitimate into a number of sections 18, e.g., N sections as shown, such that the illegitimate content 12 will pass a screening algorithm 14. That is, if the content 12 is partitioned into sections that are small enough to not be detected by the screening algorithm 14 (i.e., to not meet the time duration threshold value required by the algorithm) then such sections 18 will be permitted to pass through the screening algorithm 14. Additionally, by partitioning the content 12, the attacker is actually destroying a watermark within the content 12, thereby making it undetectable to the screening algorithm. Moreover, even if a small section of the watermark is detected by the screening algorithm, the section of content may not be rejected since the identifying watermark has likely been altered beyond recognition by the partitioning process.

Although illustrated as a separate element, screening algorithm 14 may be resident within memory within the personal computer 16, and executed by a processor of the personal computer 16. Once the content is downloaded, it may be written to a compact disk, personal digital assistant (PDA) or other device such as a memory coupled to or otherwise associated with the personal computer 16.

To complete the attack, once all of the sections 18 have passed through the screening algorithm, the partitioned sections are reassembled within the personal computer 16, to restore the integrity of the illicit content.

Personal computer 16 is an illustrative example of a processing device that may be used to implement, e.g., a program for executing the method of attacking a screening algorithm described herein. In general, such a processing device includes a processor and a memory which communicate over at least a portion of a set of one or more system buses. The device 16 may be representative of any type of processing device for use in implementing at least a portion of a method of attacking a screening algorithm in accordance with the present invention. The elements of the device 16 may correspond to conventional elements of such devices.

For example, the above-noted processor may represent a microprocessor, central processing unit (CPU), digital signal processor (DSP), or application-specific integrated circuit (ASIC), as well as portions or combinations of these and other processing devices. The memory is typically an electronic memory, but may comprise or include other types of storage devices, such as disk-based optical or magnetic memory.

The techniques described herein may be implemented in whole or in part using software stored and executed using the respective memory and processor elements of the device 16. It should be noted that the device 16 may include other elements not shown, or other types and arrangements of elements capable of providing the attack functions described herein.

The methods of attack described herein are made possible since only sections of content having a duration which is greater than a threshold value set forth in the screening algorithm were being screened by the prior screening algorithms. This type of attack would not be possible if there were no threshold value constraints and every section of the marked content were screened to ensure that the marked content is legitimate content. However, screening every section would detrimentally affect the performance of the screening algorithm since the screening algorithm is time consuming. Furthermore, when the content is partitioned into such small sections it is difficult, if not impossible, to detect a watermark in a given section. Accordingly, the above-noted screening algorithms are susceptible to being circumvented in accordance with the type of attack described herein.

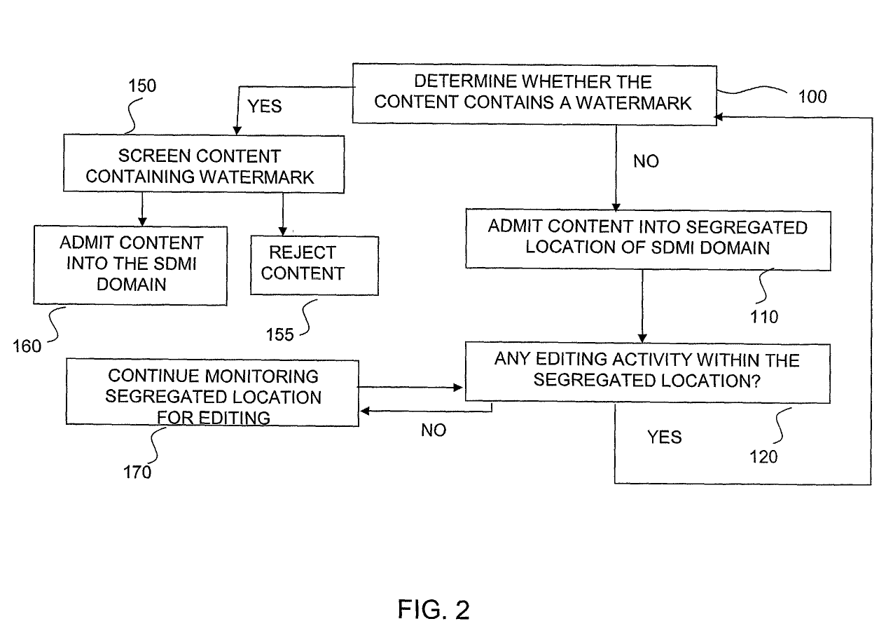

Referring now to FIG. 2, a flow diagram is shown illustrating the steps of a method of detecting illicit content that has been imported into a secure domain, in accordance with an illustrative embodiment of the present invention.

As content is identified for presentation to the screening algorithm, the first step 100 is to determine whether the content contains a watermark. If the content contains a watermark, the content will be screened according to the found watermark, as indicated by step 150. Based on the properties of the watermark, the content will either be rejected or admitted into the SDMI domain, as indicated in steps 155 and 160, respectively. A watermark embedded in the content indicates that the content is protected and should be screened according to SDMI rules.

If the content does not contain a watermark, the content will be admitted into a segregated location of the SDMI domain, as indicated by step 110. Upon admission to the SDMI domain, the content is considered “downloaded” as that term is used herein. The present invention recognizes the fact that, since the content may have been partitioned into small sections, the content may be admitted even though the content had a watermark in its original aggregate configuration. Accordingly, to prevent a successful attack by partitioning the content into small sections such that a watermark cannot be identified, a separate and secure location is established in the SDMI domain so that questionable content may be segregated from content which has been admitted into the SDMI domain without restriction, e.g., free content.

Once the content is identified as belonging in the segregated location, that content is continually monitored to determine whether there are any editing functions performed on the content, as indicated in steps 120 and 170. Editing may include joining two or more sections of content or otherwise manipulating at least a portion of the content such as, for example, by digitally altering a watermark embedded in the content. Other types of editing include, for example, rearranging the order of sections within content. It is contemplated that a watermark may be detected in the content after some editing activity, even though a watermark was not detected when the content was first submitted to the screening algorithm. For example, prior to submission to the screening algorithm, the watermark may have been manipulated to the point where it was not detected on the first pass through the screening algorithm. Thus, if editing is performed on the content, the edited content is again screened to determine whether it contains a watermark. If the edited content does contain a watermark, when it previously did not contain a watermark, this is an indication that an attack was attempted. In this case, the edited content that now has a watermark is re-screened according to SDMI rules, as indicated by step 150. It is also contemplated that, instead of rejecting the content as indicated in step 155, the content may be erased or altered in a manner such that the user cannot access or otherwise play the content. If the edited content does not contain a watermark, it is treated as free content, returned to the segregated location of the SDMI domain as indicated in step 110, and further monitored for editing activity as indicated by step 120.

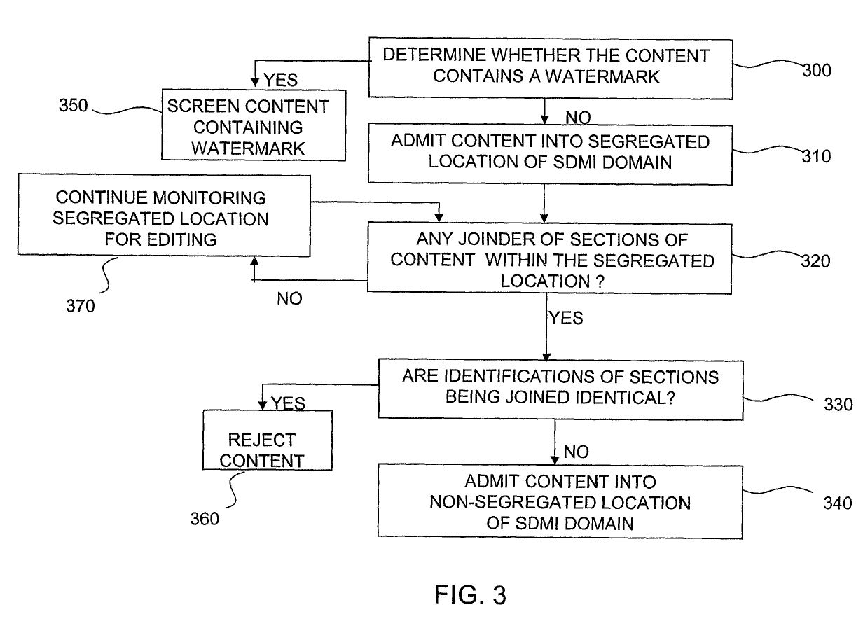

Referring now to FIG. 3, a flow diagram is shown illustrating the steps of a method of detecting illegal content that contains a watermark and has been imported into the SDMI domain, in accordance with another illustrative embodiment of the present invention.

As content is identified for presentation to the screening algorithm, the first step 300 is to determine whether the content contains a watermark. If the content contains a watermark, the content will be screened according to SDMI rules, as indicated by step 350. If the content does not contain a watermark, the content will be admitted into the previously-described segregated location of the SDMI domain, as indicated by step 310.

Once the content has been identified as belonging in the segregated location, that content is continually monitored to determine whether two or more pieces of content are joined together, as indicated in steps 320 and 370. If there is an attempt to join the sections, identification numbers associated with each of the two sections are obtained and compared to determine whether they are identical. If the identification numbers are identical, it is presumed that an attacker is attempting to reassemble content which was admitted into the SDMI domain in sections. Therefore, as indicated in step 360, when the identification numbers are identical the content is rejected. Conversely, when the identification numbers are not identical, the content is admitted into a non-segregated location of the SDMI domain, as indicated in step 340.

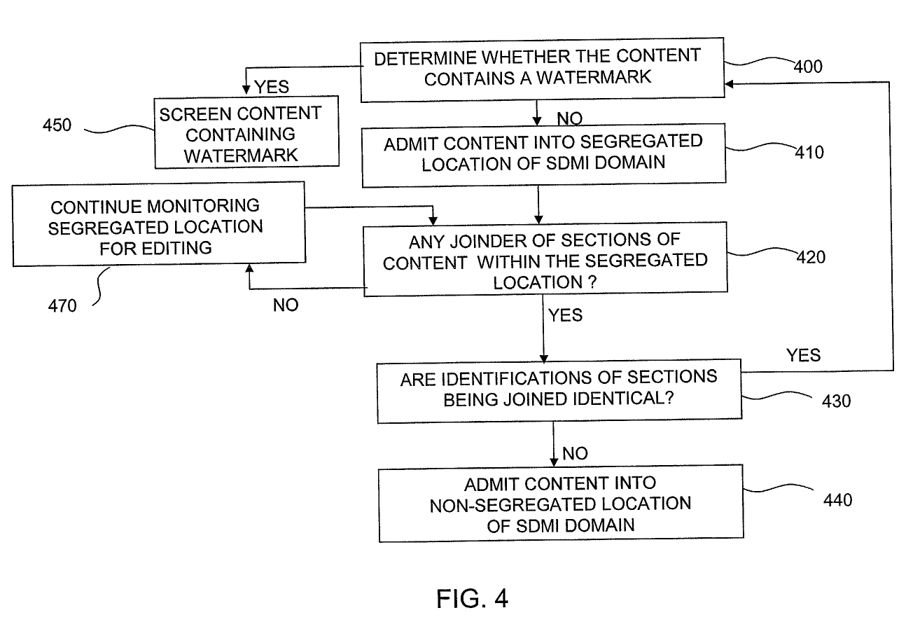

FIG. 4 shows an alternative embodiment to that described above with reference to FIG. 3. Reference numerals 400, 410, 420, 430, 440, 450 and 470 in FIG. 4 correspond generally to reference numerals 300, 310, 320, 330, 340, 350 and 370, respectively, in FIG. 3. However, in this embodiment, if the content identification numbers are identical in the two or more pieces of content that are proposed to be joined together, instead of rejecting the newly joined content, the newly joined content is resubmitted to the screening algorithm, as indicated by the arrow leading from step 430 to step 400.

The above-described embodiments of the invention are intended to be illustrative only. For example, although the present invention is described with reference to the SDMI screening algorithm and the SDMI domain, the present invention may be applied to any screening algorithm and secure domain. These and numerous other embodiments within the scope of the following claims will be apparent to those skilled in the art.

What is claimed is:

1. A method of preventing an attack on a screening algorithm, the method comprising the steps of:
determining whether content submitted to a screening algorithm contains indicia indicating that the content is protected;
admitting the content into a segregated location of a secure domain if it is determined that the content does not contain indicia indicating that the content is protected; and
monitoring the content within the segregated location to detect whether any editing activity is performed on the content.

2. The method of preventing an attack on a screening algorithm as recited in claim 1 further comprising the step of determining whether the content within the segregated location contains a watermark if editing activity is detected during the monitoring step.

3. The method of preventing an attack on a screening algorithm as recited in claim 1 wherein the indicia comprises a watermark.

4. The method of preventing an attack on a screening algorithm as recited in claim 1 wherein the editing activity includes the act of joining at least two sections of content.

5. The method of preventing an attack on a screening algorithm as recited in claim 4 further comprising the step of determining whether identification numbers associated with the sections of content being joined are identical.

6. The method of preventing an attack on a screening algorithm as recited in claim 5 further comprising the step of rejecting the edited content if the identification numbers associated with the sections of content being joined are identical.

7. The method of preventing an attack on a screening algorithm as recited in claim 1 further comprising the step of determining whether the edited content contains indicia indicating that the content is protected after editing activity is detected.

8. The method of preventing an attack on a screening algorithm as recited in claim 7 further comprising the step of admitting the content into a non-segregated location of the secure domain if it is determined that the content does not contain indicia indicating that the content is protected after editing activity is detected.

9. The method of preventing an attack on a screening algorithm as recited in claim 7 further comprising the step of rejecting the content from entry into a non-segregated location of the secure domain if it is determined that the content does contain indicia indicating that the content is protected after editing activity is detected.

10. The method of preventing an attack on a screening algorithm as recited in claim 7 further comprising the step of erasing the content if it is determined that the content does contain indicia indicating that the content is protected after editing activity is performed.

11. The method of preventing an attack on a screening algorithm as recited in claim 1 wherein the screening algorithm is a Secure Digital Music Initiative screening algorithm.

12. The method of preventing an attack on a screening algorithm as recited in claim 1, wherein the determining, admitting and monitoring steps are performed by a processing device.

13. An apparatus for preventing an attack on a screening algorithm comprising:
a processing device having a processor coupled to a memory, the processing device being operative to
determine whether content includes a watermark,
admit content that does not have a watermark into a segregated location of a secure domain if it is determined that the watermark does not indicate that the content is protected, and
monitor the segregated location for editing activity with respect to the content.

14. The apparatus for preventing an attack on a screening algorithm as recited in claim 13, wherein the memory associated with the processing device is configured to store the content when the content is admitted into the secure domain by the screening algorithm.

15. An article of manufacture for preventing an attack on a screening algorithm, the article comprising a machine readable medium containing one or more programs which when executed implement the steps of:
determining whether content submitted to a screening algorithm contains indicia indicating that the content is protected from downloading;
admitting the content into a segregated location of a secure domain if it is determined that the content does not contain indicia indicating that the content is protected; and
monitoring the content within the segregated location to detect whether any editing activity is performed on the content.
